(19) United States
(12) Patent Application Publication
(10) Pub. No.: US 2024/0404305 A1
(43) Pub. Date: Dec. 5, 2024

(54) INFORMATION PROCESSING APPARATUS, METHOD, AND NON-TRANSITORY COMPUTER-READABLE STORAGE MEDIUM STORING PROGRAM

(71) Applicant: CANON KABUSHIKI KAISHA, Tokyo (JP)

(72) Inventor: TOMOYA ISHIDA, Kanagawa (JP)

(21) Appl. No.: 18/672,130

(22) Filed: May 23, 2024

(30) Foreign Application Priority Data
Jun. 2, 2023 (JP) 2023-091835

(51) Int. Cl. G06V 20/70; G06V 10/764; G06V 10/77; G06V 10/82; G06V 10/94; G06V 40/16

(52) U.S. Cl. CPC G06V 20/70; G06V 10/764; G06V 10/7715; G06V 10/82; G06V 10/945; G06V 40/161; G06V 40/172

(57) ABSTRACT

An information processing apparatus acquires an image, extracts a feature portion from the acquired image, accepts a word corresponding to the extracted feature portion, acquires a category of the extracted feature portion, and replaces a word that is related to the acquired category and included in a comment inferred by an inference unit based on the acquired image with the accepted word.

### BACKGROUND OF THE INVENTION

### Cross-Reference to Priority Application

This application claims the benefit of Japanese Patent Application No. 2023-091835, filed Jun. 2, 2023, which is hereby incorporated by reference herein in its entirety.

### FIELD OF THE INVENTION

The present invention relates to an information processing apparatus, a method, and a non-transitory computer-readable storage medium storing a program.

### DESCRIPTION OF THE RELATED ART

There is conventionally known a technique of inputting an image and automatically generating a comment that explains the image. Japanese Patent Laid-Open No. 2018-147205 describes extracting a proper noun from a text and converting the proper noun into a more understandable proper noun. There is also known a technique of automatically generating a comment from, for example, an image captured by a user.

### SUMMARY OF THE INVENTION

A comment automatically generated from an image is versatile and is not always a comment desired by the user. Further improvement is required concerning automatic comment generation.

The present invention provides an information processing apparatus that appropriately generates, from an image, a comment desired by a user, a method, and a non-transitory computer-readable storage medium storing a program.

The present invention in one aspect provides an information processing apparatus comprising: at least one memory and at least one processor which function as: a first acquisition unit configured to acquire an image; an extraction unit configured to extract a feature portion from the image acquired by the first acquisition unit; an acceptance unit configured to accept a word corresponding to the feature portion extracted by the extraction unit; a second acquisition unit configured to acquire a category of the feature portion extracted by the extraction unit; and a conversion unit configured to replace a word that is related to the category acquired by the second acquisition unit and included in a comment inferred by an inference unit based on the image acquired by the first acquisition unit with the word accepted by the acceptance unit.

According to the present invention, it is possible to appropriately generate, from an image, a comment desired by a user.

Further features of the present invention will become apparent from the following description of exemplary embodiments with reference to the attached drawings.

### BRIEF DESCRIPTION OF THE DRAWINGS

FIG. 1 is a view showing the configuration of a system;

FIG. 2 is a view showing the hardware configuration of each apparatus;

FIG. 3 is a view showing the configuration of software of a PC;

FIG. 4 is a view showing the configuration of an application;

FIG. 5 is a view showing a user interface screen;

FIG. 6 is a view showing a user interface screen;

FIG. 7 is a flowchart showing processing in an information processing apparatus;

FIG. 8 is a flowchart showing processing in the information processing apparatus;

FIG. 9 is a view showing a model for inferring a comment from an image;

FIG. 10 is a view showing comment candidate lists;

FIG. 11 is a view showing a user interface screen;

FIG. 12 is a view showing a user interface screen;

FIG. 13 is a view showing a user interface screen;

FIG. 14 is a view showing a user interface screen; and

FIG. 15 is a view showing a user interface screen.

### DESCRIPTION OF THE EMBODIMENTS

Hereafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

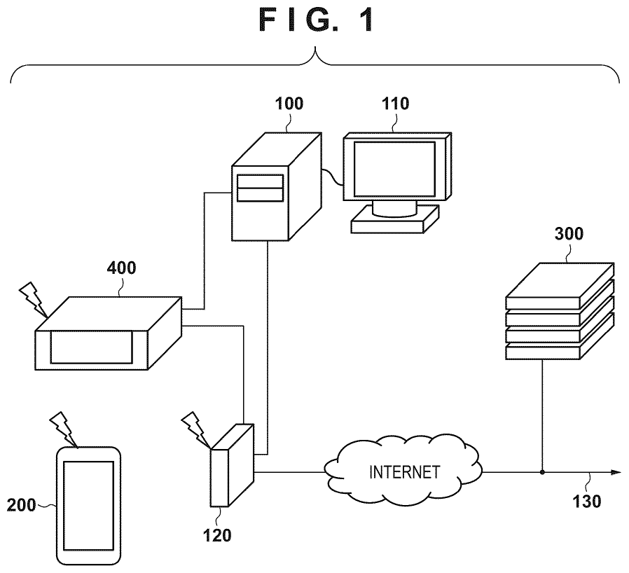

FIG. 1 is a view showing an example of the configuration of a printing system in this embodiment. This printing system includes a client computer (to be referred to as a PC hereinafter) 100, a display (display device) 110, a router 120, a mobile terminal 200, a server computer (to be referred to as a server hereinafter) 300, and a printer 400. The PC 100 is connected to the display 100 by a communication cable, and displays various kinds of user interface screens on the display 110 for the user of the PC 100. An information processing apparatus may include not only the PC 100 itself but also the PC 100 and the display 110. The PC 100 is also connected to the router 120 by wired communication or wireless communication, and can mutually communicate with another communication device through Internet 130 via the router 120. The mobile terminal 200 can mutually communicate with another communication device through the Internet 130 via the router 120 by wireless communication. The server 300 is, for example, a Web server that provides a Web application by which the user can create/edit content data to be printed. The server 300 can mutually communicate with another communication device through the Internet 130. The server 300 receives data held by the PC 100 or the mobile terminal 200, and stores it in a memory. The server 300 can process the data, or transmit the data to another communication device such as the PC 100. The printer 400 receives data stored in the PC 100, the mobile terminal 200, or the server 300, and prints it on a print medium such as a print sheet.

In the printing system shown in FIG. 1, the user of the PC 100 can print, by the printer 400, the content created using the Web application of the server 300. The user of the PC 100 can also print the print target content by the printer 400 while using not the Web application of the server 300 but the native application installed on the PC 100 in advance. The user of the PC 100 can associate the Web application and the native application with each other in advance such that these can cooperate and print the content, which has been created by the Web application, by the printer 400 via the native application. In this embodiment, the application used by the user to print the content on the PC 100 is simply referred to as the “application” regardless of the above-described modes. The hardware configuration of each apparatus shown in FIG. 1 will be described below.

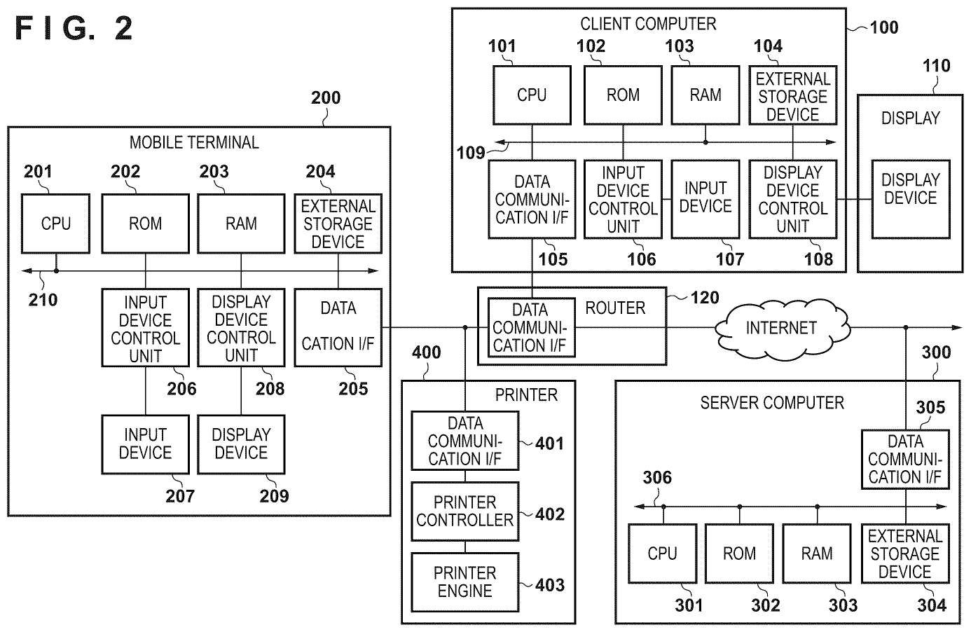

FIG. 2 is a view showing an example of the hardware configuration of each apparatus of the printing system shown in FIG. 1. First, the hardware configuration of the PC 100 will be described. A CPU 101 is a central processing unit, and comprehensively controls the PC 100 serving as the information processing apparatus. A ROM 102 is a nonvolatile storage, and holds various kinds of data, programs, and tables. For example, a basic program and various kinds of application programs are stored in the ROM 102. The application programs include, for example, the print application program downloaded from an external server and installed, and the frontend program in the Web application of the server 300. A RAM 103 is a volatile storage, and temporarily holds programs and data. An external storage device 104 is a nonvolatile storage such as a Hard Disk Drive (HDD) or a Solid State Drive (SDD), and holds programs and data. The CPU 101 executes various kinds of processes based on the programs and data stored in the ROM 102, the RAM 103, and the external storage device 104. For example, the operation of the PC 100 in this embodiment is implemented when the CPU 101 reads out the program stored in the ROM 102 into the RAM 103 and executes the program.

A data communication interface (I/F) 105 executes data communication with an external device. For example, the data communication I/F 105 controls, via the router 120, data transmission/reception with the server 300 and the printer 400. As the data communication method, for example, a wired connection method such as a USB, IEEE 1394, or a LAN, or a wireless connection method such as Bluetooth® or WiFiR is used. An input device control unit 106 acquires information concerning a user operation accepted via an input device 107, and transmits the information to the CPU 101. The input device 107 is a Human Interface Device (HID) including a keyboard, a mouse, and the like. A display device control unit 108 converts screen data for the user interface screen or the like into drawing data, and transmits the drawing data to the display 110 to display it. The blocks in the PC 100 are mutually connected via an internal bus 109. The configuration of the PC 100 is not limited to the configuration shown in FIG. 2, and the PC 100 includes components, as needed, corresponding to functions that a device applied as the PC 100 can execute.

Next, the hardware configuration of the mobile terminal 200 will be described. The mobile terminal 200 mainly has functions of an information processing apparatus such as a tablet computer or a smartphone, and includes a touch panel used for both display and an input I/F. A CPU 201 is a central processing unit, and comprehensively controls the mobile terminal 200. A ROM 202 is a nonvolatile storage, and holds various kinds of data and programs. For example, a basic program and various kinds of application programs are stored in the ROM 202. A RAM 203 is a volatile storage, and temporarily holds programs and data. An external storage device 204 is a nonvolatile storage such as a Hard Disk Drive (HDD) or a Solid State Drive (SSD), and holds programs and data. The external storage device 204 may be configured to be externally attached. The CPU 201 executes various kinds of processes based on the programs and data stored in the ROM 202, the RAM 203, and the external storage device 204. For example, the operation of the mobile terminal 200 in this embodiment is implemented when the CPU 201 reads out the program stored in the ROM 202 into the RAM 203 and executes the program.

A data communication I/F 205 executes data communication with an external device. As the data communication method, for example, a wired connection method such as a USB, IEEE 1394, or a LAN, or a wireless connection method such as Bluetooth or WiFi is used. An input device control unit 206 acquires information concerning a user operation accepted via an input device 207, and transmits the information to the CPU 201. The input device 207 is, for example, a device that can accept an input operation on a screen such as a touch panel having a display function and an input function, which is included in a tablet computer or a smartphone. A display device control unit 208 converts screen data for the user interface screen or the like into drawing data, and causes a display device 209 to display the drawing data. The blocks in the mobile terminal 200 are mutually connected via an internal bus 210. The configuration of the mobile terminal 200 is not limited to the configuration shown in FIG. 2, and the mobile terminal 200 has components, as needed, corresponding to functions that a device applied as the mobile terminal 200 can execute.

Next, the hardware configuration of the server 300 will be described. A CPU 301 is a central processing unit, and comprehensively controls the server 300. A ROM 302 is a nonvolatile storage, and holds various kinds of table data and programs. For example, a basic program and various kinds of application programs are stored in the ROM 302. The application programs include, for example, a print application that the user can download. A RAM 303 is a volatile storage, and temporarily holds programs and data. An external storage device 304 is a nonvolatile storage such as a Hard Disk Drive (HDD) or a Solid State Drive (SDD), and holds programs and data. For example, the operation of the server 300 in this embodiment is implemented when the CPU 301 reads out the program stored in the ROM 302 into the RAM 303 and executes the program.

A data communication I/F 305 executes data communication with an external device. For example, the data communication I/F 305 controls, via the router 120, data transmission/reception with the PC 100 and the printer 400. As the data communication method, for example, a wired connection method such as a USB, IEEE 1394, or a LAN, or a wireless connection method such as Bluetooth or WiFi is used. The blocks in the server 300 are mutually connected via an internal bus 306. The configuration of the server 300 is not limited to the configuration shown in FIG. 2, and the server 300 has components, as needed, corresponding to functions that a device applied as the server 300 can execute.

Next, the hardware configuration of the printer 400 will be described. A data communication I/F 401 executes data communication with an external device. For example, the data communication I/F 401 controls, via the router 120, data transmission/reception with the PC 100 and the server 300. As the data communication method, for example, a wired connection method such as a USB, IEEE 1394, or a LAN, or a wireless connection method such as Bluetooth or WiFi is used.

The printer 400 can receive print data generated by the PC 100, the mobile terminal 200, and the server 300, and print the data on print media. Note that the print data includes image data to be printed, and print setting data defining a print setting. A printer controller 402 controls a printer engine 403 based on the print data received from the external device.

For example, the printer controller 402 performs, on the image data, color space conversion and color separation processing into color materials corresponding to the sheet type defined by the print setting data, thereby generating the print data that the printer engine 403 can process. The printer controller 402 also performs image processing such as output tone correction or halftoning using an image processing parameter such as a lookup table.

The printer engine 403 converts the image data of the print data into ink color data for each ink used in the printer 400, and executes a printing process. Note that the printer engine 403 has the configuration corresponding to the printing method of the printer 400. For example, in this embodiment, the printer 400 is assumed to be an inkjet printer that executes printing on a print medium by an inkjet printing method. In this case, the printer engine 403 is formed while including ink tanks storing respective inks, and a printhead provided with a nozzle array for discharging ink droplets. In the printing process, based on the print data, the heating operation or the like of the heater mounted on the printhead is controlled to control nozzles so as to discharge ink droplets.

The configuration of the printer 400 is not limited to the configuration in FIG. 2, and the printer 400 has components, as needed, corresponding to functions that a device applied as the printer 400 can execute. Further, the printer 400 is not limited to a printer using the inkjet printing method, and may be a printer using another printing method such as an electrophotographic method. The printer 400 may be a MultiFunctional Peripheral (MFP) that integrates the functions of a scanner, a facsimile, and the like.

The server 300 is, for example, a Web server that provides a Web application by which the user can create/edit content data (for example, poster image data) to be printed. In this case, the software of the server 300 is formed while including a frontend that controls display of the Web browser on the PC 100 or the like, and a backend. The frontend manages/holds a program (JavaScript) to be executed on the Web browser. For example, when the program is transmitted (downloaded) to the PC 100, the Web browser on the PC 100 performs corresponding display. The frontend includes, for example, a program for performing user authentication and a program for performing content creation/edition processing. Note that in a state in which the program of the frontend has been downloaded on the PC 100, this program becomes a part of the software configuration of the PC 100.

In this embodiment, as an example of an application capable of creating/editing content data, a native application installed in the PC 100 in advance is assumed. Note that a printer driver corresponding to the printer 400 is installed on the PC 100. However, a configuration may be used in which the user creates/edits content such as a poster by the frontend on the PC 100 side, and the backend on the server 300 side executes a rendering process. In this case, when a print instruction is accepted from the user, the frontend instructs the backend to execute printing based on the print setting for the printer driver, and transmits the content data created/edited by the user to the backend. The backend performs a rendering process on the transmitted content data, and transmits it to the PC 100. The content data having undergone the rendering process is printed by the printer corresponding to the printer driver.

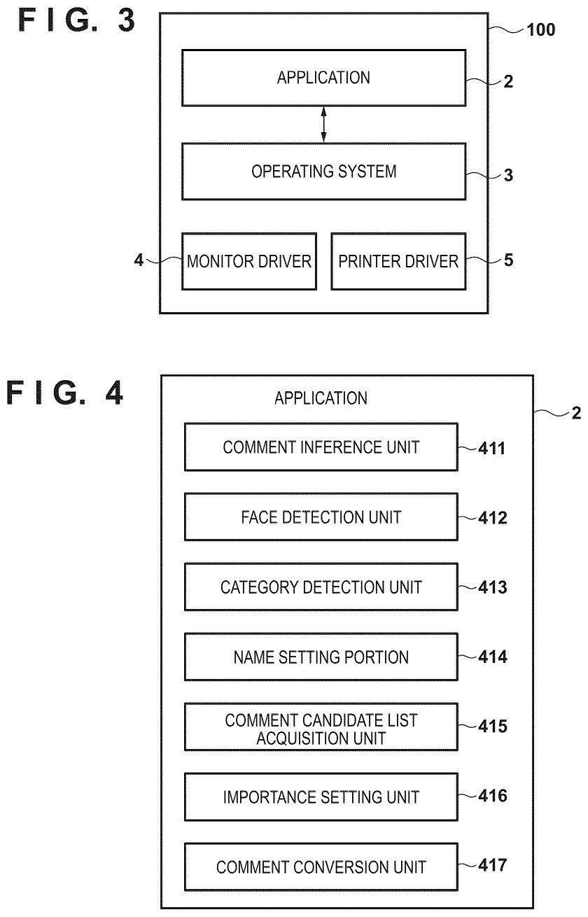

FIG. 3 is a view showing an example of the configuration of software of the PC 100. The PC 100 includes, as the software configuration, an application 2, an operating system 3, a monitor driver 4, and a printer driver 5.

In this embodiment, the application 2 is, for example, an application configured to create/edit a poster. Note that the application 2 is assumed to be a native application installed in the PC 100 in advance, but may be a program of the frontend of a Web application. The application 2 issues various kinds of drawing processing command groups (an image drawing command, a text drawing command, a graphics drawing command, and the like) for outputting execution results of processes such as creation/editing. The drawing command groups issued by the application 2 are input to the monitor driver 4 via the operating system 3. If a drawing processing command group is associated with printing, the drawing command group issued by the application 2 is input to the printer driver 5 via the operating system 3. The printer driver 5 is software configured to create print data by processing an input drawing processing command group and cause the printer 400 to print it. The monitor driver 4 is software configured to create display data by processing an input drawing processing command group and cause the display 110 to display it.

The application 2 creates output image data using text data classified into a text such characters, graphics data classified into graphics such as a graphic pattern, and image data classified into an image or the like. The output image data can be displayed on the display 110. For example, the application 2 displays a poster image of output image data that is the target of creation/editing by the user on the user interface screen of the application 2. Also, when accepting a user instruction on the user interface screen and printing an image based on the output image data, the application 2 requests the operating system 3 to do print output. In these cases, a drawing processing command group in which a text data portion is formed by a text drawing command, a graphics data portion is formed by a graphics drawing command, and an image data portion is formed by an image drawing command is issued to the operating system 3.

FIG. 4 is a view showing an example of the configuration of the application 2. The application 2 includes a comment inference unit 411, a face detection unit 412, a category detection unit 413, a name setting unit 414, a comment candidate list acquisition unit 415, an importance setting unit 416, and a comment conversion unit 417. In the following explanation, the application 2 will be described as poster creation software 500.

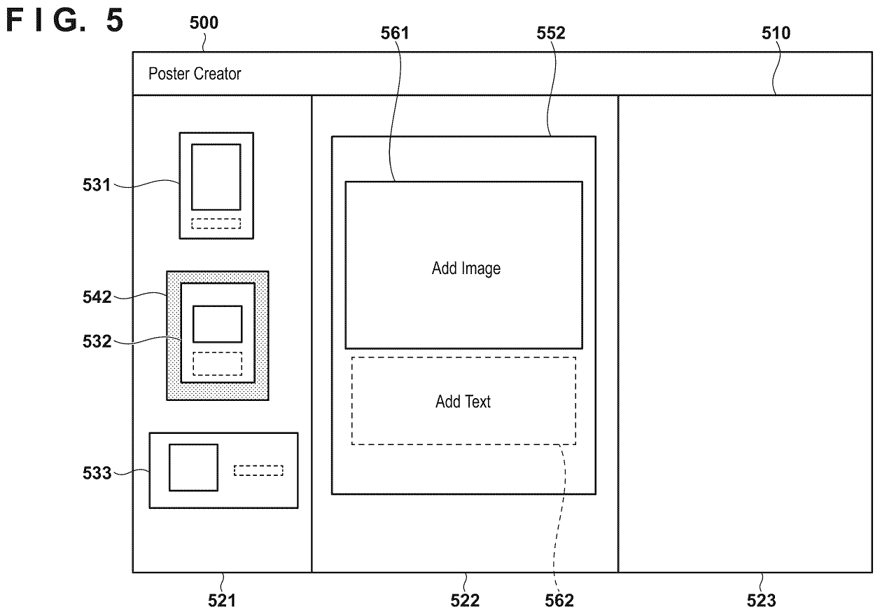

FIG. 5 is a view showing an example of the editing screen of the poster creation software 500. An editing screen 510 of the poster creation software 500 is configured to include a template list region 521, a template editing region 522, and a person setting region 523. In the template list region 521, templates 531, 532, and 533 prepared in advance are displayed. The user selects a desired template from the template list region 521. FIG. 5 shows a state in which the user selects the template 532, and the template is in a selected state 542. The template 532 selected from the template list 521 is displayed as an editing target template 552 in the template editing region 522. An image setting portion 561 used by the user to set an image, and a comment setting portion 562 for setting a comment to the image are arranged in the editing target template 552.

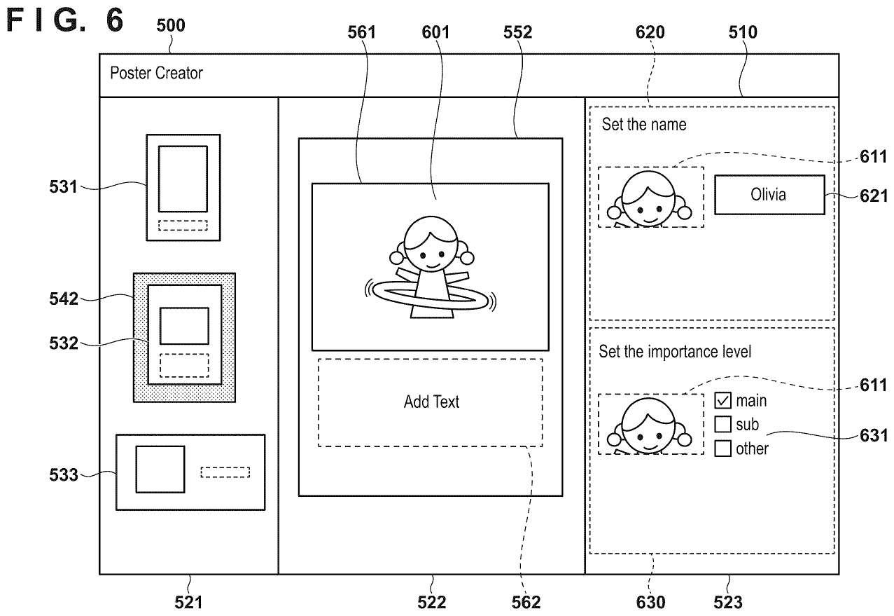

FIG. 6 shows a state in which an image of a user is set in the image setting portion 561 on the editing screen 510 of the poster creation software 500. The user performs an operation such as drag & drop of an image (to be referred to as a user image hereinafter) captured by himself/herself and held to the image setting portion 561, thereby setting the user image in the image setting portion 561. The user image may be an image captured by the user and held in the PC 100, or may be an image acquired via the Internet. If a user image 601 is set in the image setting portion 561, the person setting region 523 is displayed. In the person setting region 523, a name setting portion 620 that sets the name of a detected person and an importance level setting portion 630 that sets the importance level of the detected person are arranged. In the name setting portion 620, a face region 611 detected as a feature portion in the user image 601, and a field 621 (to be referred to as the name setting field 621 hereinafter) for setting the name of a person included in the face region 611 are arranged. The user can input the name of the user to the name setting field 621. In FIG. 6, the user sets a name “Olivia”.

In the importance level setting portion 630, the face region 611 detected in the user image 601, and an importance level setting field 631 used to set the importance level of the person included in the face region 611 are displayed. In FIG. 6, the importance level can be set in three stages “main”, “sub”, and “other”, and “main” is set. “Main” indicates that the importance level is high, “sub” indicates that the importance level is medium, and “other” indicates that the importance level is low. The user can select these importance levels. In this example, the importance level is set in three stages. However, the stages are not limited to three stages, and the importance level may be set in two stages “important” and “not”, or may be set in four or more stages.

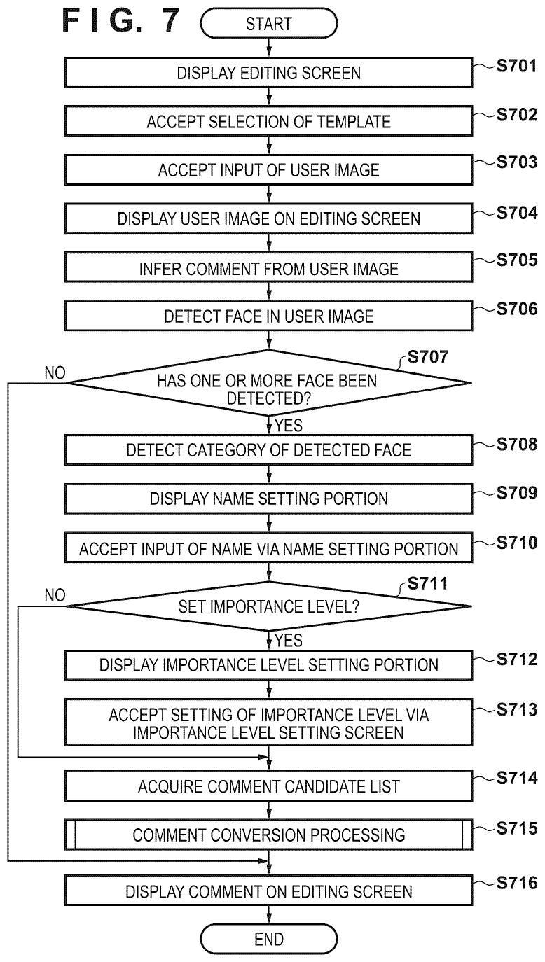

FIG. 7 is a flowchart showing comment display processing according to this embodiment. Processing shown in FIG. 7 is implemented by, for example, the CPU 101 reading out a program stored in the ROM 102 to the RAM 103 and executing it. Also, processing shown in FIG. 7 is started when, for example, the poster creation software 500 is activated.

In step S701, the CPU 101 displays the editing screen 510 of the poster creation software 500. In step S702, the CPU 101 displays a list of templates in the template list region 521 and accepts selection of a template desired by the user. If the user selects a template, in step S703, the CPU 101 accepts, in the image setting portion 561 of the template editing region 522, input of a user image from the user. If the user image is input, in step S704, the CPU 101 displays the user image in the image setting portion 561. In step S705, the CPU 101 infers a comment from the user image using the comment inference unit 411. Here, the inferred comment is called an inferred comment.

FIG. 9 shows a model for inferring a comment from an image. The user image 601 is, for example, an image of a girl playing with a hula hoop, and the user image 601 is input to the model. The input user image 601 is converted into a feature map by a Convolutional Neural Network (CNN) 901. The feature map is input to a Long Short-Term Memory (LSTM) 902, and an inferred comment 910 is output. The inferred comment 910 is thus generated from the user image 601. This model performs learning in advance using a set of an enormous number of images and comments thereof. In this example, a model using LSTMs has been described. In this embodiment, the model is not limited to this, and another network such as a Recurrent Neural Network (RNN) may be used, and any model that infers a comment from an image can be used.

In step S706, the CPU 101 detects a face in the user image 601 by the face detection unit 412. In step S707, the CPU 101 determines whether one or more faces are detected as the result of the process of step S706. Upon determining that one or more faces are detected, in step S708, the CPU 101 detects the category of the detected face by the category detection unit 413. Upon determining that no face is detected, the process advances to step S716.

In the processes of steps S706 and S708, for example, a method using Region Base Convolutional Neural Network (R-CNN) is used. R-CNN is a method based on a CNN, in which an object candidate region is extracted from an input image, and the CNN is applied to the candidate region, thereby extracting a feature map and performing class classification. However, the embodiment is not limited to the method using R-CNN, and any method that specifies the position of an object in an image and specifies the type of the object can be used.

In step S709, the CPU 101 displays the name setting portion 620. In step S710, the CPU 101 accepts input of a name for the detected face from the user via the name setting portion 620.

In step S711, the CPU 101 determines whether to set an importance level for the detected face. Note that whether to set an importance level may be decided in advance by the poster creation software 500. Alternatively, it may be settable in the poster creation software 500. In this case, the determination process of step S711 is done based on the set contents of the poster creation software 500. Upon determining to set an importance level, in step S712, the CPU 101 displays the importance level setting portion 630. In step S713, the CPU 101 accepts a setting of an importance level from the user via the importance level setting portion 630. In step S714, the CPU 101 acquires a comment candidate list by the comment candidate list acquisition unit 415.

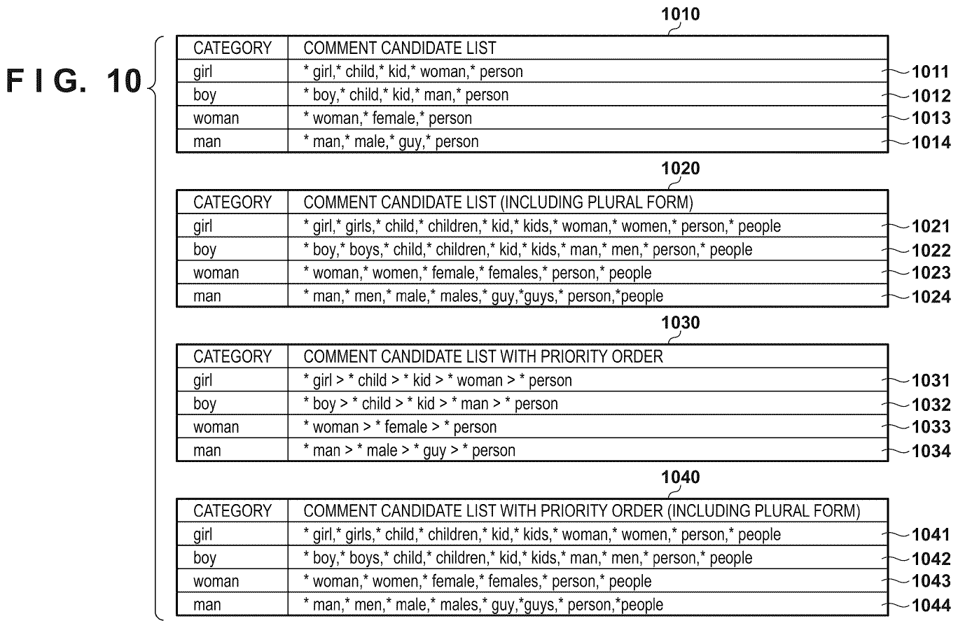

FIG. 10 is a view for explaining a comment candidate list. In a comment candidate list, words that can be inferred by the comment inference unit 411 for categories (for example, “girl”, “boy”, and the like) obtained by object detection are held as a list of comment candidates. For example, in a case of an image including a girl, the face of the girl is detected by the face detection unit 412, and a category “girl” is detected by the category detection unit 413. When a comment for this image is inferred by the comment inference unit 411, for example, a comment “A little girl . . . ” or “A cute child . . . ” is inferred. In this case, “A little girl” and “A cute child” are comment candidates related to the category “girl”.

As a comment candidate creation method, for example, a word that has a relationship of a synonym or equivalent word with a word of a category is obtained as a comment candidate. However, the method is not limited to this, and another method may be used. For example, a comment candidate may be extracted from a comment used in learning of an inference model. Since there are a plurality of comment candidates for a category, these are held in a list. In this embodiment, the list is called a comment candidate list. Since a comment candidate list exists for each category, in this embodiment, a set of lists will be referred to as a comment candidate list table. FIG. 10 shows comment candidate list tables 1010, 1020, 1030, and 1040 as an example.

The comment candidate list table 1010 includes the following comment candidate lists.
(1) A comment candidate list 1011 for a category “girl”
(2) A comment candidate list 1012 for a category “boy”
(3) A comment candidate list 1013 for a category “woman”
(4) A comment candidate list 1014 for a category “man”

For example, the comment candidate list 1011 indicates “*girl, *child, *kid, *woman, *person”, and this means that four comment candidates “*girl”, “*child”, “*kid”, and “*person” are held. Here, “*” is a wild card of regular expression. For example, a character string such as “A girl” or “A little girl” corresponds to “*girl”. Here, each comment candidate is represented by a regular expression. However, the present invention is not limited to this, and a simple word such as “Girl”, which is not a regular expression, may be used.

The comment candidate list table 1020 includes the following comment candidate lists.
(1) A comment candidate list 1021 for a category “girl”
(2) A comment candidate list 1022 for a category “boy”
(3) A comment candidate list 1023 for a category “woman”
(4) A comment candidate list 1024 for a category “man”

For example, the comment candidate list 1021 indicates “*girl, *girls, *child, *children, *kid, *kids, *woman, *women, *person, *people”, and this means that eight comment candidates are held. Unlike the comment candidate list 1011, “*children, *kids, *women, and *people”, which are plural forms, are included. Since a comment inferred by the comment inference unit 411 is sometimes expressed in a plural form, comment candidates including such plural forms may be used.

The comment candidate list table 1030 includes the following comment candidate lists.
(1) A comment candidate list 1031 for a category “girl”
(2) A comment candidate list 1032 for a category “boy”
(3) A comment candidate list 1033 for a category “woman”
(4) A comment candidate list 1034 for a category “man”

For example, the comment candidate list 1031 indicates “*girl>*child>*kid>*woman>*person”. The comment candidates are “*girl”, “*child”, “*kid”, “*woman”, and “*person”, which are the same as the comment candidate list 1011. However, priority order is set in the comment candidate list 1031. For example, the priority order of “*girl” is higher than that of “*child”. A symbol “>” indicates the priority order. The priority order may be set based on, for example, the similarity between words for a word of a category. For example, the similarity between the category “girl” and the comment candidate “*child” is calculated, and the priority order is set based on the similarity. When calculating the similarity, “*” is removed, and the similarity between words is calculated for the category “girl” and the comment candidate “child”. As a detailed similarity calculation method, for example, a method of converting a word into a vector expression by the method of Word2Vec and calculating the cosine similarity may be used. The similarity between the category and the comment candidate is calculated in this way. The higher the similarity is, the higher the priority order is set. As for the calculation of the similarity, a method using Word2Vec has been described. However, the method is not limited to this, and another method may be used.

The comment candidate list table 1040 includes the following comment candidate lists.
(1) A comment candidate list 1041 for a category “girl”
(2) A comment candidate list 1042 for a category “boy”
(3) A comment candidate list 1043 for a category “woman”
(4) A comment candidate list 1044 for a category “man”

The comment candidate lists 1041, 1042, 1043, and 1044 include plural forms in addition to the above-described comment candidate lists with priority order. Since a comment inferred by the comment inference unit 411 is sometimes expressed in a plural form, comment candidates including such plural forms may be used.

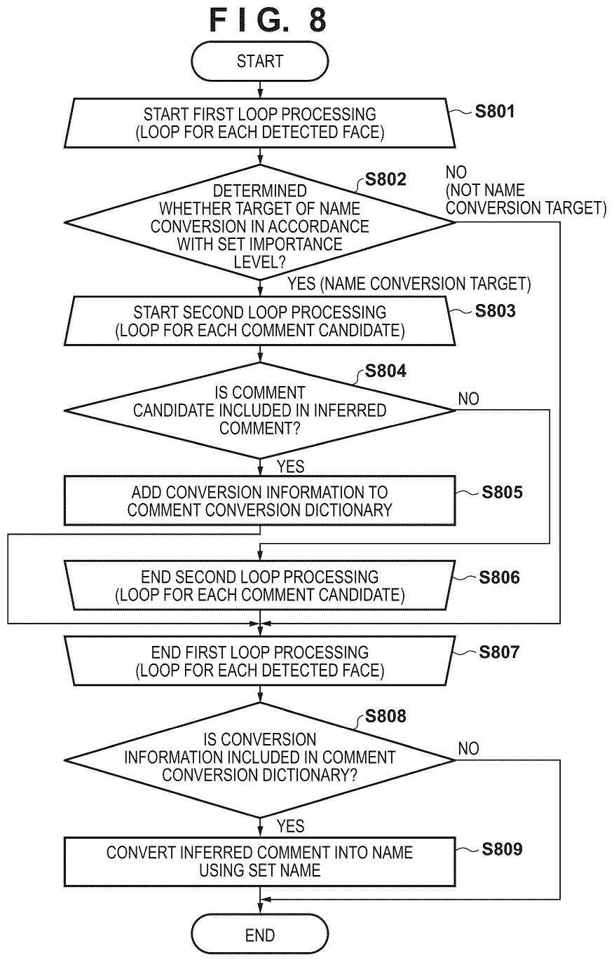

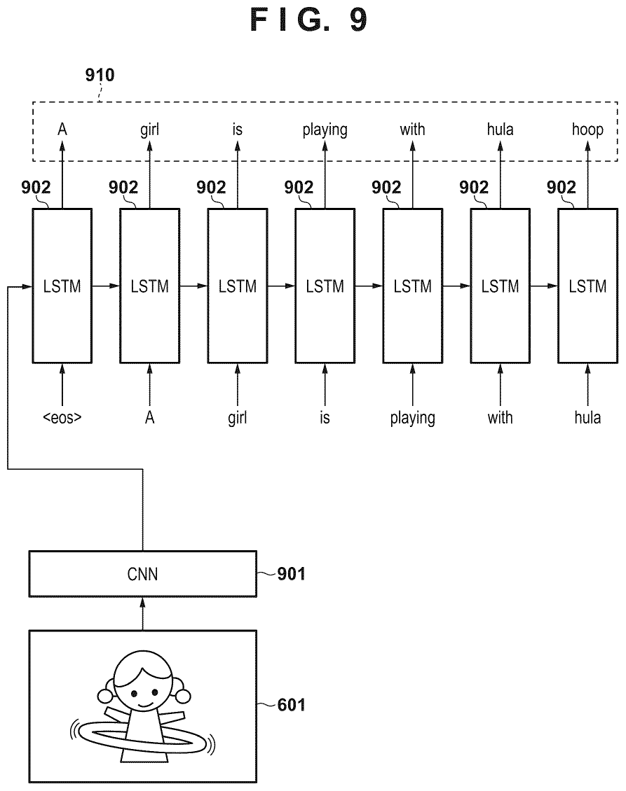

In step S715, the CPU 101 executes comment conversion processing by the comment conversion unit 417. In the following explanation, a comment that has undergone the conversion will be referred to as a converted comment. The comment conversion processing will be described with reference to FIG. 8.

In step S716, the CPU 101 displays a comment in the comment setting portion 562. If comment conversion processing is performed in step S715, the comment displayed here is a converted comment. On the other hand, upon determining in step S707 that no face is detected, the displayed comment is an inferred comment. After step S716, the processing shown in FIG. 7 is ended.

FIG. 8 is a flowchart showing the comment conversion processing of step S715. First, the CPU 101 executes loop processing such that repetitive processes of steps S801 to S807 are performed as many times as the number of faces detected in step S706. Here, the loop processing will be referred to as first loop processing.

In step S802, the CPU 101 determines, based on the importance level set in the importance level setting portion 630, whether the current face of interest in the first loop processing is a name conversion target. In this embodiment, if importance level setting is not performed for the detected face, condition determination of step S802 is always “YES”, and the process advances to step S803. If importance level setting is performed, and it is determined, based on the importance level setting, that the face is not a name conversion target, the first loop processing is skipped concerning the face. For example, if “other” representing a predetermined importance level is set in the importance level setting portion 630, it is determined that the face is not a name conversion target.

Upon determining in step S802 that the face is a name conversion target, the CPU 101 executes loop processing such that repetitive processes of steps S803 to S806 are performed as many times as the number of comment candidates included in the comment candidate list. Here, the loop processing will be referred to as second loop processing.

In step S804, for each current comment candidate of interest in the second loop processing, the CPU 101 determines whether the comment candidate is included in the inferred comment. Upon determining that the current comment candidate of interest in the second loop processing is included in the inferred comment, in step S805, the CPU 101 adds, to a comment conversion dictionary, the information of a pair of a matching character string in the inferred comment and the name of the conversion target (to be referred to as conversion information hereinafter). The comment conversion dictionary defines a combination for converting a character string and a name and is used to convert a character string included in an inferred comment. An example of the comment conversion dictionary will be described later. After the conversion information is added to the comment conversion dictionary, the CPU 101 ends the second loop processing. If the processing is ended for all detected faces, the CPU 101 ends the first loop processing.

In step S808, the CPU 101 determines whether the conversion information is included in the comment conversion dictionary. Upon determining that the conversion information is included in the comment conversion dictionary, in step S809, the CPU 101 converts the inferred comment into a converted comment based on the comment conversion dictionary.

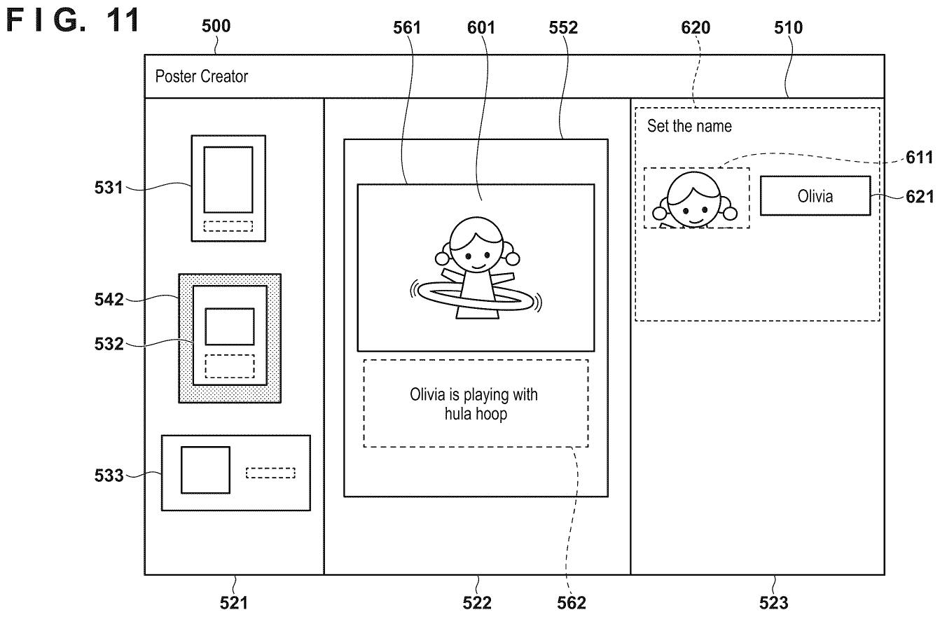

The processes shown in FIGS. 7 and 8 will be described below using an example of a user image shown in FIG. 11.

FIG. 11 shows an example in a case where this embodiment is applied to the user image 601 of a girl playing with a hula hoop. FIG. 11 shows a state in which the processes of steps S701 to S704 have been executed. The CPU 101 infers a comment from the user image 601 by the comment inference unit 411, and acquires an inferred comment “A girl is playing with hoop” (step S705). Next, the CPU 101 detects a face in the user image 601 by the face detection unit 412, and acquires the face region 611 (step S706). Then, the CPU 101 acquires the category “girl” of the face region 611 by the category detection unit 413 (step S708). Next, the CPU 101 sets the name of the face region 611 by the name setting unit 414 (steps S709 and S710). As shown in FIG. 11, “Olivia” is set in the name setting field 621. In this example, importance level setting is off by the setting of the poster creation software 500, and it is set not to do importance level setting. That is, in step S711, it is determined not to set an importance level.

Then, the CPU 101 acquires the comment candidate list table 1010 by the comment candidate list acquisition unit 415 (step S714). In this example, the comment candidate list 1011 “*girl, *child, *kid, *woman, *person” for the category “girl” is acquired from the comment candidate list table 1010.

Next, the CPU 101 performs comment conversion processing by the comment conversion unit 417 as many times as the number of detected faces (step S715). In a case of the user image 601, since one face is detected, the execution count of the first loop processing in steps S801 to S807 is 1. In this example, since the importance level setting is set off by the poster creation software 500, all detected faces are name conversion targets (YES in step S802).

Since the acquired comment candidate list 1011 includes five elements, the execution count of the second loop processing in steps S803 to S806 is 5. The CPU 101 determines whether “*girl” included in the comment candidate list 1011 is included in the inferred comment (step S804). Here, upon determining that “*girl” is not included, the CPU 101 determines whether another comment candidate “*child” is included in the inferred comment “A girl is playing with hoop”. In this way, the CPU 101 determines the comment candidates included in the comment candidate list 1011 one by one. In this example, since the comment candidate “*girl” matches a character string “A girl” in the inferred comment, the process advances from step S804 to step S805. The CPU 101 then adds the pair of the matching character string and the name to be converted to the comment conversion dictionary (step S805). In this example, conversion information representing that “A girl” is converted into “Olivia” (to be expressed as conversion information “A girl”→“Olivia” hereinafter) is added to the comment conversion dictionary. Then, the CPU 101 determines whether the conversion information is included in the comment conversion dictionary (step S808).

Upon determining that the conversion information is included, the CPU 101 converts the inferred comment into a converted comment “Olivia is playing with hula hoop” using the comment conversion dictionary (step S809). The CPU 101 displays the converted comment in the comment setting portion 562 (step S716).

As described above, according to this embodiment, the category is extracted based on the face detected in the image. Then, based on the fact that the comment candidate list corresponding to the category is included in the inferred comment, the inferred comment is converted into a converted comment including the name set by the user. This makes it possible to appropriately generate a comment desired by the user based on the inferred comment formed by versatile words.

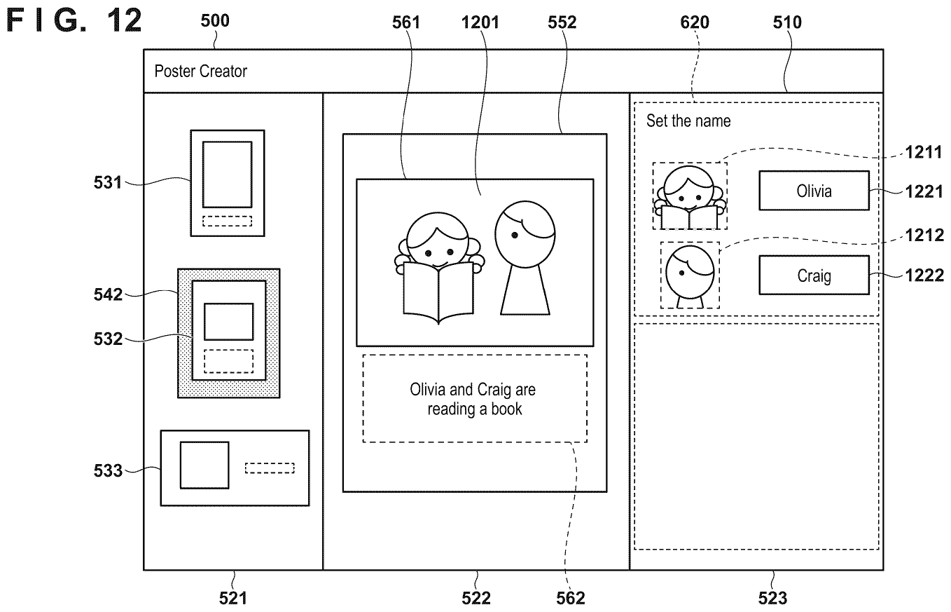

FIG. 12 shows an example in a case where this embodiment is applied to an image 1201 of a girl and a man who are reading a book. FIG. 12 shows a state in which the processes of steps S701 to S704 have been executed. The CPU 101 infers a comment from the user image 1201 by the comment inference unit 411, and acquires an inferred comment “A little child and a man are reading a book” (step S705). Next, the CPU 101 detects faces in the user image 1201 by the face detection unit 412, and acquires face regions 1211 and 1212 (step S706). Then, the CPU 101 acquires the category “girl” of the face region 1211 and the category “man” of the face region 1212 by the category detection unit 413 (step S708). Next, the CPU 101 sets the names of the face regions 1211 and 1212 by the name setting unit 414 (steps S709 and S710). As shown in FIG. 12, in this example, “Olivia” is set in a name setting field 1221, and “Craig” is set in a name setting field 1222. In this example, importance level setting is off by the setting of the poster creation software 500, and it is set not to do importance level setting. That is, in step S711, it is determined not to set an importance level.

Then, the CPU 101 acquires the comment candidate list table 1010 by the comment candidate list acquisition unit 415 (step S714). In this example, the comment candidate list 1011 “*girl, *child, *kid, *woman, *person” for the category “girl” is acquired from the comment candidate list table 1010. In addition, the comment candidate list 1014 “*man, *male, *guy, *person” for the category “man” is acquired.

Next, the CPU 101 performs comment conversion processing by the comment conversion unit 417 as many times as the number of detected faces (step S715). In a case of the user image 1201, since two faces are detected, the execution count of the first loop processing in steps S801 to S807 is 2. In this example, the first loop processing is executed first for the face region 1211.

Since the category of the face region 1211 is “girl”, the comment candidate list 1011 is acquired. Since the comment candidate list 1011 includes five elements, the execution count of the second loop processing in steps S803 to S806 for the face region 1211 is 5. The CPU 101 determines whether “*girl” included in the comment candidate list 1011 is included in the inferred comment (step S804). Here, upon determining that “*girl” is not included, the CPU 101 determines whether another comment candidate “*child” is included in the inferred comment. In this way, the CPU 101 determines the comment candidates included in the comment candidate list 1011 one by one. In this example, since the comment candidate “*child” matches a character string “A little child” in the inferred comment, the process advances from step S804 to step S805. The CPU 101 then adds conversion information “A little child”→“Olivia” to the comment conversion dictionary (step S805).

Next, the CPU 101 executes the first loop processing for the face region 1212. Since the category of the face region 1212 is “man”, the comment candidate list 1014 is acquired. Since the comment candidate list 1014 includes four elements, the execution count of the second loop processing for the face region 1212 is 4. First, the CPU 101 determines whether “*man” included in the comment candidate list 1014 is included in the inferred comment (step S804). Here, upon determining that “*man” is not included, the CPU 101 determines whether another comment candidate “*male” is included in the inferred comment. In this way, the CPU 101 determines the comment candidates included in the comment candidate list 1014 one by one. In this example, since the comment candidate “*man” matches a character string “a man” in the inferred comment, the process advances from step S804 to step S805. The CPU 101 then adds conversion information “a man”→“Craig” to the comment conversion dictionary (step S805).

In a case of the user image 1201, since two faces are detected, the first loop processing is ended here. As described above, since addition to the comment conversion dictionary is performed, in step S808, it is determined that the conversion information is included in the comment conversion dictionary. Then, the CPU 101 converts the inferred comment into a converted comment “Olivia and Craig are reading a book” using the comment conversion dictionary (step S809). The CPU 101 displays the converted comment in the comment setting portion 562 (step S716).

As described above, according to this embodiment, if the categories of the plurality of faces detected in the image are different, it is possible to appropriately generate a comment desired by the user from the image in accordance with the case.

Note that in this example, the first loop processing is executed first for the girl. However, the present invention is not limited to this, and the conversion processing can be executed in any order. Also, the conversion processing may be executed in descending order of importance level set by the importance level setting unit 416.

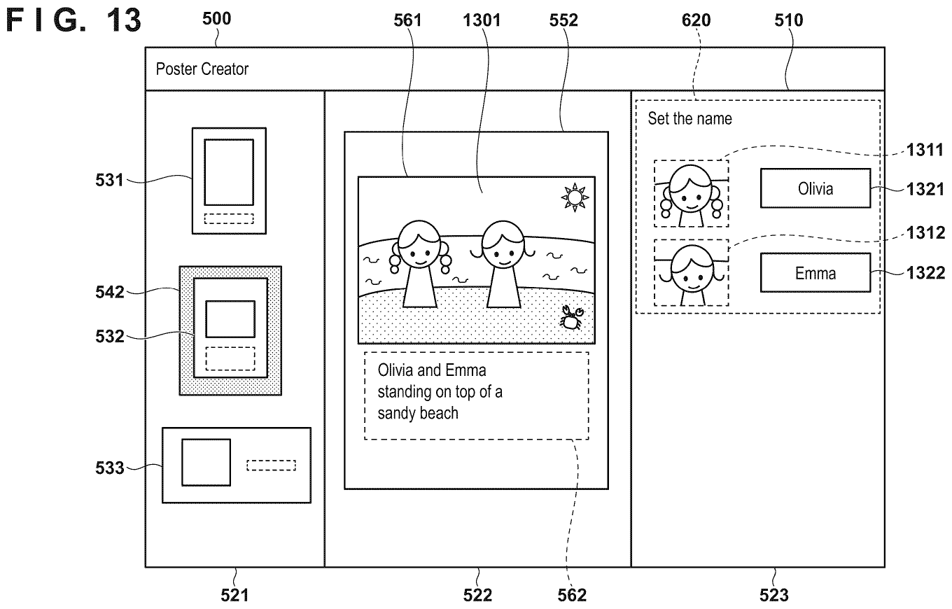

FIG. 13 shows an example in a case where this embodiment is applied to an image 1301 of two girls on a beach. FIG. 13 shows a state in which the processes of steps S701 to S704 have been executed. The CPU 101 infers a comment from the user image 1301 by the comment inference unit 411, and acquires an inferred comment “A couple of people standing on top of a sandy beach” (step S705). Next, the CPU 101 detects faces in the user image 1301 by the face detection unit 412, and acquires face regions 1311 and 1312 (step S706). Then, the CPU 101 acquires the category “girl” of the face region 1311 and the category “girl” of the face region 1312 by the category detection unit 413 (step S708). Next, the CPU 101 sets the names of the face regions 1311 and 1312 by the name setting unit 414 (steps S709 and S710). As shown in FIG. 13, in this example, “Olivia” is set in a name setting field 1321, and “Emma” is set in a name setting field 1322. In this example, importance level setting is off by the setting of the poster creation software 500, and it is set not to do importance level setting. That is, in step S711, it is determined not to set an importance level.

Then, the CPU 101 acquires the comment candidate list table 1020 by the comment candidate list acquisition unit 415 (step S714). Here, the comment candidate list is acquired from the comment candidate list table 1020 because a plurality of faces of the same category (“girl” in this example) are detected. If a plurality of faces of the same category are detected, the comment inferred by the comment inference unit 411 often includes a plural form. For example, “girls” may be included in the inferred comment in a case where a plurality of faces of the category “girl” are detected. In this case, if a plurality of faces of the same category are detected, a comment candidate list including plural forms is used. However, the present invention is not limited to this. Even if a plurality of faces of the same category are detected, a comment candidate list including only singulars may be used. Conversely, even if only one face of a certain category is detected, a comment candidate list including plural forms may be used. In this example, the comment candidate list 1021 “*girl, *girls, *child, *children, *kid, *kids, *woman, *women, *person, *people” for the category “girl” is acquired from the comment candidate list table 1020.

Next, the CPU 101 performs comment conversion processing by the comment conversion unit 417 as many times as the number of detected faces (step S715). In a case of the user image 1301, since two faces are detected, the execution count of the first loop processing in steps S801 to S807 is 2. In this example, the first loop processing is executed first for the face region 1311.

Since the category of the face region 1311 is “girl”, the comment candidate list 1021 is acquired. Since the comment candidate list 1021 includes 10 elements, the execution count of the second loop processing in steps S803 to S806 for the face region 1311 is 10. The CPU 101 determines whether “*girl” included in the comment candidate list 1021 is included in the inferred comment (step S804). Here, upon determining that “*girl” is not included, the CPU 101 determines whether another comment candidate “*girls” is included in the inferred comment. In this way, the CPU 101 determines the comment candidates included in the comment candidate list 1021 one by one. In this example, since the comment candidate “*people” matches a character string “A couple of people” in the inferred comment, the process advances from step S804 to step S805. The CPU 101 then adds conversion information “A couple of people”→“Olivia” to the comment conversion dictionary (step S805).

Next, the CPU 101 executes the first loop processing for the face region 1312. Since the category of the face region 1312 is “girl”, the comment candidate list 1021 is acquired. Since the comment candidate list 1021 includes 10 elements, the execution count of the second loop processing for the face region 1312 is 10. First, the CPU 101 determines whether “*girl” included in the comment candidate list 1021 is included in the inferred comment (step S804). Here, upon determining that “*girl” is not included, the CPU 101 determines whether another comment candidate “*girls” is included in the inferred comment. In this way, the CPU 101 determines the comment candidates included in the comment candidate list 1021 one by one. In this example, since the comment candidate “*people” matches a character string “A couple of people” in the inferred comment, the process advances from step S804 to step S805. The CPU 101 then adds conversion information “A couple of people”→“Emma” to the comment conversion dictionary (step S805).

In a case of the user image 1301, since two faces are detected, the first loop processing is ended here. As described above, since addition to the comment conversion dictionary is performed, in step S808, it is determined that the conversion information is included in the comment conversion dictionary. Then, the CPU 101 converts the inferred comment using the comment conversion dictionary. In this example, since two conversion targets “Olivia” and “Emma” exist for “A couple of people”, the CPU 101 connects these by a conjunction “and” and converts them into “Olivia and Emma” (step S809). Finally, the inferred comment is converted into a converted comment “Olivia and Emma standing on top of a sandy beach”. The CPU 101 displays the converted comment in the comment setting portion 562 (step S716).

As described above, according to this embodiment, if the plurality of faces detected in the image belong to the same category, it is possible to appropriately generate a comment desired by the user from the image in accordance with the case.

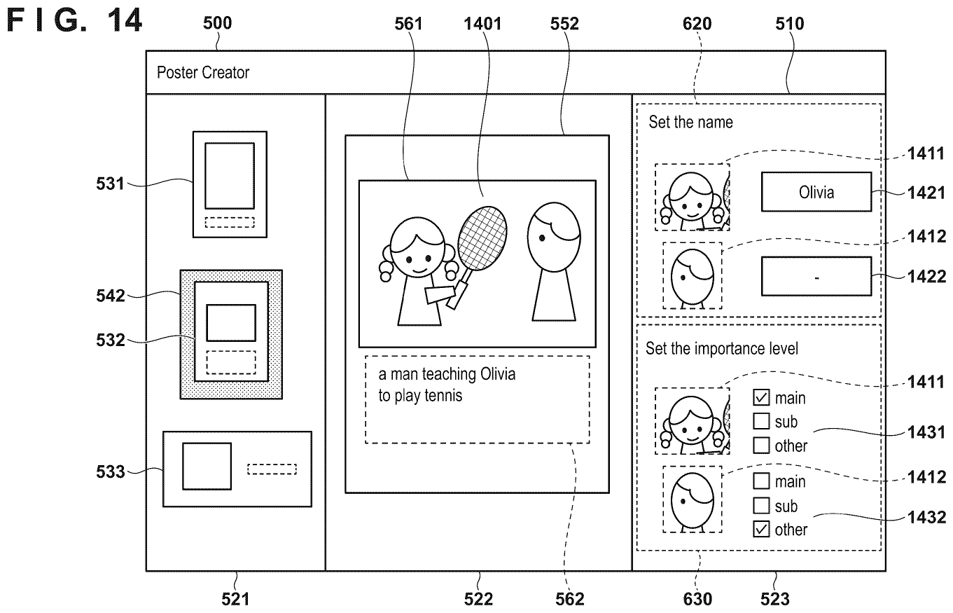

FIG. 14 shows an example in a case where this embodiment is applied to an image 1401 of playing tennis. FIG. 14 shows a state in which the processes of steps S701 to S704 have been executed. The CPU 101 infers a comment from the user image 1401 by the comment inference unit 411, and acquires an inferred comment “a man teaching a girl to play tennis” (step S705). Next, the CPU 101 detects faces in the user image 1401 by the face detection unit 412, and acquires face regions 1411 and 1412 (step S706). Then, the CPU 101 acquires the category “girl” of the face region 1411 and the category “man” of the face region 1412 by the category detection unit 413 (step S708). Next, the CPU 101 sets the names of the face regions 1411 and 1412 by the name setting unit 414 (steps S709 and S710). As shown in FIG. 14, in this example, “Olivia” is set in a name setting field 1421, and nothing is set in a name setting field 1422. In this example, the man of the face region 1412 is teaching the girl of the face region 1411 to play tennis. For the face region 1412, no name is set, and the name of the man is not included in the final converted comment.

Then, the CPU 101 acquires the comment candidate list table 1010 by the comment candidate list acquisition unit 415 (step S714). In this example, the comment candidate list 1011 “*girl, *child, *kid, *woman, *person” for the category “girl” is acquired from the comment candidate list table 1010, and the comment candidate list 1014 “*man, *male, *guy, *person” for the category “man” is acquired.

Next, the CPU 101 sets the importance level of each person by the importance level setting unit 416 (steps S712 and S713). In the importance level setting portion 630, an importance level setting field 1431 and an importance level setting field 1432 are provided. In this example, for the face region 1411, importance level “main” is set in the importance level setting field 1431. For the face region 1412, importance level “other” is set in the importance level setting field 1432.

Next, the CPU 101 performs comment conversion processing by the comment conversion unit 417 as many times as the number of detected faces (step S715). In a case of the user image 1401, since two faces are detected, the execution count of the first loop processing in steps S801 to S807 is 2. In this example, the first loop processing is executed sequentially in descending order of priority set by the importance level setting unit 416. In this example, since the priority order of the face region 1411 is higher than that of the face region 1412, the first loop processing is executed first from the face region 1411 with the high priority order.

Since the category of the face region 1411 is “girl”, the comment candidate list 1011 is acquired. Since the comment candidate list 1011 includes five elements, the execution count of the second loop processing in steps S803 to S806 for the face region 1411 is 5. The CPU 101 determines whether “*girl” included in the comment candidate list 1011 is included in the inferred comment (step S804). Here, upon determining that “*girl” is not included, the CPU 101 determines whether another comment candidate “*child” is included in the inferred comment. In this way, the CPU 101 determines the comment candidates included in the comment candidate list 1011 one by one. In this example, since the comment candidate “*girl” matches a character string “a girl” in the inferred comment, the process advances from step S804 to step S805. The CPU 101 then adds conversion information “a girl”→“Olivia” to the comment conversion dictionary (step S805).

Next, the CPU 101 executes the first loop processing for the face region 1412. As described above, concerning the face region 1412, the importance level is set to “other”. For this reason, it is determined that the face region 1412 is not a name conversion target (NO in step S802), and name conversion processing is not executed for the face region 1412.

In a case of the user image 1401, since two faces are detected, the first loop processing is ended here. As described above, since addition to the comment conversion dictionary is performed, in step S808, it is determined that the conversion information is included in the comment conversion dictionary. Then, the CPU 101 converts the inferred comment into a converted comment “a man teaching Olivia to play tennis” by the comment conversion dictionary (step S809). The CPU 101 displays the converted comment in the comment setting portion 562 (step S716).

As described above, according to this embodiment, if importance levels are set between the plurality of faces detected in the image, it is possible to appropriately generate a comment desired by the user from the image in accordance with the case.

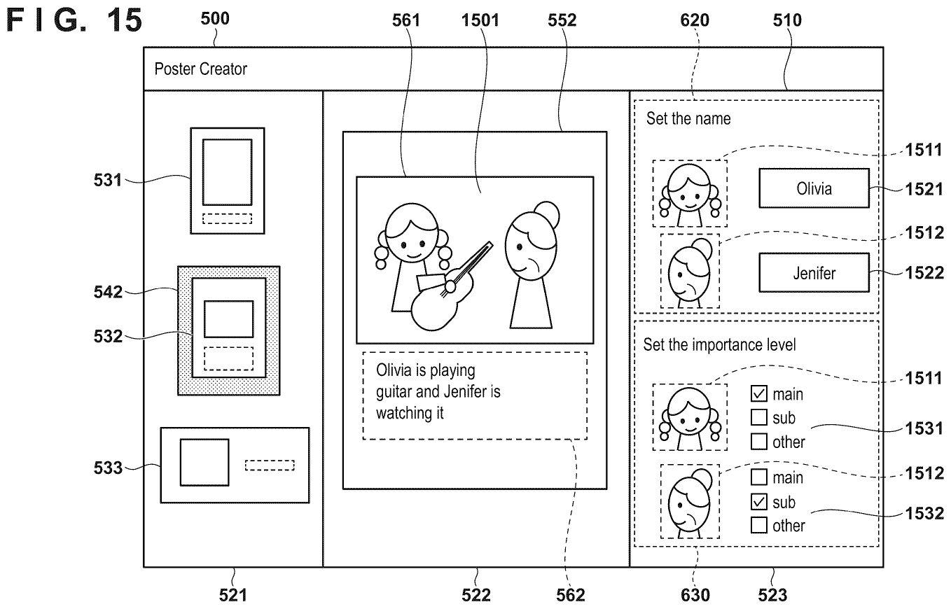

FIG. 15 shows an example in a case where this embodiment is applied to an image 1501 of a girl playing a guitar. FIG. 15 shows a state in which the processes of steps S701 to S704 have been executed. The CPU 101 infers a comment from the user image 1501 by the comment inference unit 411, and acquires an inferred comment “a little girl is playing guitar and a woman is watching it” (step S705). Next, the CPU 101 detects faces in the user image 1501 by the face detection unit 412, and acquires face regions 1511 and 1512 (step S706). Then, the CPU 101 acquires the category “girl” of the face region 1511 and the category “woman” of the face region 1512 by the category detection unit 413 (step S708). Next, the CPU 101 sets the names of the face regions 1511 and 1512 by the name setting unit 414 (steps S709 and S710). As shown in FIG. 15, in this example, “Olivia” is set in a name setting field 1521, and “Jenifer” is set in a name setting field 1522. Then, the CPU 101 acquires the comment candidate list table 1030 by the comment candidate list acquisition unit 415 (step S714). In this example, the comment candidate list 1031 “*girl>*child>*kid>*woman>*person” for the category “girl” is acquired from the comment candidate list table 1030. In addition, the comment candidate list 1033 “*woman>*female>*person” for the category “woman” is acquired. These comment candidate lists are lists with priority order.

Next, the CPU 101 sets the importance level of each person by the importance level setting unit 416 (steps S712 and S713). In the importance level setting portion 630, an importance level setting field 1531 and an importance level setting field 1532 are provided. In this example, for the face region 1511, importance level “main” is set in the importance level setting field 1531. For the face region 1512, importance level “sub” is set in the importance level setting field 1532.

Next, the CPU 101 performs comment conversion processing by the comment conversion unit 417 as many times as the number of detected faces (step S715). In a case of the user image 1501, since two faces are detected, the execution count of the first loop processing in steps S801 to S807 is 2. In this example, the first loop processing is executed in descending order of priority order set by the importance level setting unit 416. In this example, since the priority order of the face region 1511 is higher than that of the face region 1512, the first loop processing is executed first from the face region 1511 with the high priority order.

Since the category of the face region 1511 is “girl”, the comment candidate list 1031 is acquired. Since the comment candidate list 1031 includes five elements, the execution count of the second loop processing in steps S803 to S806 for the face region 1511 is 5. In this example, since the comment candidate list 1031 is a list with priority order, the second loop processing is performed sequentially in descending order of priority. First, since “*girl” included in the comment candidate list 1031 has the highest priority order, the CPU 101 determines whether “*girl” is included in the inferred comment (step S804). Here, upon determining that “*girl” is not included, the CPU 101 determines whether “*child” that is a comment candidate with the second highest priority order is included in the inferred comment. In this way, the CPU 101 determines the comment candidates included in the comment candidate list 1031 one by one. In this example, since the comment candidate “*girl” matches a character string “a little girl” in the inferred comment, the process advances from step S804 to step S805. The CPU 101 then adds conversion information “a little girl”→ “Olivia” to the comment conversion dictionary (step S805).

Next, the CPU 101 executes the first loop processing for the face region 1512. Since the category of the face region 1512 is “woman”, the comment candidate list 1033 is acquired. Since the comment candidate list 1033 includes three elements, the execution count of the second loop processing for the face region 1512 is 3. The CPU 101 determines whether “*woman” included in the comment candidate list 1033 is included in the inferred comment (step S804). Here, upon determining that “*woman” is not included, the CPU 101 determines whether “*female” that is another comment candidate is included in the inferred comment. In this way, the CPU 101 determines the comment candidates included in the comment candidate list 1033 one by one. In this example, since the comment candidate “*woman” matches a character string “a woman” in the inferred comment, the process advances from step S804 to step S805. The CPU 101 then adds conversion information “a woman”→“Jenifer” to the comment conversion dictionary (step S805).

In a case of the user image 1501, since two faces are detected, the first loop processing is ended here. As described above, since addition to the comment conversion dictionary is performed, in step S808, it is determined that the conversion information is included in the comment conversion dictionary. Then, the CPU 101 converts the inferred comment into a converted comment “Olivia is playing guitar and Jenifer is watching it” by the comment conversion dictionary (step S809). The CPU 101 displays the converted comment in the comment setting portion 562 (step S716).

If not the comment candidate list 1031 but the comment candidate list 1011 that is not a list with priority order is used, the second loop processing may be executed first not for “*girl” but for “*woman”. In this case, since “*woman” matches “a woman” in the inferred comment, the final converted comment is “a little girl is playing guitar and Olivia is watching it”. As a result, Olivia is watching a little girl playing a guitar, and this cannot correctly express the comment of the user image 1501. In this embodiment, a comment candidate list with priority order is used, thereby generating a correct converted comment.

In this embodiment, detection of a person face as a feature portion has been described. However, an animal such as a pet may be detected. In the above-described embodiment, an example in which a comment is inferred in English has been described. However, the language is not limited to English, and may be another language. Also, in this embodiment, the name of a person is set as a name. However, the present invention is not limited to this, and a nickname of a person or a pet may be used. In this embodiment, poster creation software has been described. However, the present invention is not limited to this. Any software that creates a comment for an image, such as photo album creation software or software for creating a postcard, may be used.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An information processing apparatus comprising:
at least one memory and at least one processor which function as:
a first acquisition unit configured to acquire an image;
an extraction unit configured to extract a feature portion from the image acquired by the first acquisition unit;
an acceptance unit configured to accept a word corresponding to the feature portion extracted by the extraction unit;
a second acquisition unit configured to acquire a category of the feature portion extracted by the extraction unit; and
a conversion unit configured to replace a word that is related to the category acquired by the second acquisition unit and included in a comment inferred by an inference unit based on the image acquired by the first acquisition unit with the word accepted by the acceptance unit.

2. The apparatus according to claim 1, wherein the conversion unit replaces the word included in the comment inferred by the inference unit with the word accepted by the acceptance unit, thereby converting the inferred comment.

3. The apparatus according to claim 1, further comprising a display unit configured to display the comment converted by the conversion unit together with the image acquired by the first acquisition unit.

4. The apparatus according to claim 1, further comprising a storage unit configured to store the category and the word related to the category in association with each other.

5. The apparatus according to claim 4, wherein the category and the word related to the category have a relationship of synonyms or equivalent words.

6. The apparatus according to claim 4, wherein the storage unit stores a plurality of words associated with the category.

7. The apparatus according to claim 6, wherein the at least one processor further functions as:
a determination unit configured to determine whether each of the plurality of words is included in the inferred comment,
wherein if the determination unit determines that the word is included in the inferred comment, the conversion unit replaces the word determined to be included with the word accepted by the acceptance unit.

8. The apparatus according to claim 7, wherein a priority order is set for each of the plurality of words, and
the determination unit determines, based on the priority order, whether each of the plurality of words is included in the inferred comment.

9. The apparatus according to claim 7, wherein, if the second acquisition unit acquires different categories for a first feature portion and a second feature portion of the image acquired by the first acquisition unit,
a first word determined to be included in the inferred comment by the determination unit based on the category of the first feature portion is replaced with a second word accepted by the acceptance unit and corresponding to the first feature portion, and
a third word determined to be included in the inferred comment by the determination unit based on the category of the second feature portion is replaced with a fourth word accepted by the acceptance unit and corresponding to the second feature portion.

10. The apparatus according to claim 7, wherein, if the second acquisition unit acquires the same category for a third feature portion and a fourth feature portion of the image acquired by the first acquisition unit, a fifth word determined to be included in the inferred comment by the determination unit represents a plural form.

11. The apparatus according to claim 10, wherein the fifth word is replaced with a sixth word accepted by the acceptance unit and corresponding to the third feature portion and a seventh word accepted by the acceptance unit and corresponding to the fourth feature portion.

12. The apparatus according to claim 11, wherein the fifth word is replaced, using a conjunction, with the sixth word and the seventh word.

13. The apparatus according to claim 7, wherein the at least one processor further functions as:
a setting unit configured to set an importance level for each of a fifth feature portion and a sixth feature portion of the image acquired by the first acquisition unit, and
determination by the determination unit is executed based on setting by the setting unit.

14. The apparatus according to claim 13, wherein, if the importance level set by the setting unit is a predetermined importance level, for the feature portion for which the predetermined importance level is set, the determination by the determination unit is not performed, and the replacement is not performed.

15. The apparatus according to claim 13, wherein, if the setting unit sets a first importance level for the fifth feature portion, and the setting unit sets a second importance level lower than the first importance level for the sixth feature portion, the determination by the determination unit is performed first for the fifth feature portion rather than the sixth feature portion.

16. The apparatus according to claim 1, wherein the feature portion is a face.

17. The apparatus according to claim 1, wherein the word accepted by the acceptance unit and corresponding to the feature portion is a name unique to a person, and the word included in the inferred comment is a versatile name, and
the conversion information replaces the versatile name with the unique name.

18. The apparatus according to claim 1, wherein the inference unit is a model using Long Short-Term Memory (LSTM).

19. A method executed in an information processing apparatus, the method comprising:
acquiring an image;
extracting a feature portion from the acquired image;
accepting a word corresponding to the extracted feature portion;
acquiring a category of the extracted feature portion; and
replacing a word that is related to the acquired category and included in a comment inferred by an inference unit based on the acquired image with the accepted word.

20. A non-transitory computer-readable storage medium storing one or more programs configured to cause one or more computers of an information processing apparatus to function as:
a first acquisition unit configured to acquire an image;
an extraction unit configured to extract a feature portion from the image acquired by the first acquisition unit;
an acceptance unit configured to accept a word corresponding to the feature portion extracted by the extraction unit;
a second acquisition unit configured to acquire a category of the feature portion extracted by the extraction unit; and
a conversion unit configured to replace a word that is related to the category acquired by the second acquisition unit and included in a comment inferred by an inference unit based on the image acquired by the first acquisition unit with the word accepted by the acceptance unit.
